(19) United States
(12) Patent Application Publication
(10) Pub. No.: US 2018/0192261 A1
(43) Pub. Date: Jul. 5, 2018

(54) DYNAMIC VIDEO MESSAGE SYSTEM STORED IN AN ACCESSIBLE STORAGE MEDIUM OF A PORTABLE DEVICE

(71) Applicant: Zeppelin Corporation, Apia (WS)

(72) Inventor: Kuo-Ching CHIANG, New Taipei (TW)

(21) Appl. No.: 15/823,417

(22) Filed: Nov. 27, 2017

(30) Foreign Application Priority Data
Dec. 29, 2016 (TW) 105144322
Nov. 3, 2017 (TW) 106138169

(51) Int. Cl. H04W 4/12; H04L 12/58

(52) U.S. Cl. CPC H04W 4/12; H04M 1/72555; H04L 51/38

(57) ABSTRACT

A dynamic video message system stored in an accessible storage medium of a portable device, and coupled to a control unit of the portable device, wherein the dynamic video message system includes: a dynamic video address book provider to access to directory information; a dynamic video message generator coupled to the dynamic video address book provider and provided to generate a dynamic video message; and a transport provider coupled to the dynamic video message generator to handle message transmission and reception.

### CROSS-REFERENCE TO RELATED APPLICATIONS

This patent application claims the benefit of a foreign patent application of serial number 105144322 filed to TAIWAN Patent Office on filed Dec. 29, 2016, also, this patent application claims the benefit of a foreign patent application of serial number 106138169 filed to TAIWAN Patent Office on Nov. 3, 2017.

### TECHNICAL FIELD

The present invention relates to a message system, and in particular to a dynamic video message system stored in an access-able storage medium of a portable device.

### BACKGROUND

The electronic products develop rapidly in the trend of lightness, thinness, shortness, smallness, multi-function and fast speed as information technology and computer markets expand increasingly. The telecommunication network and the Internet are newly risen industries in recent years because of the coming of high tech era. The communication system continuously provides the user with a method to obtain information more conveniently with the development of the mobile phone integration technology. Therefore, the communication technology becomes a new favorite with a leap, and the auxiliary business in the communication device also develops vigorously due to the convenience of contact and the acquirement of information. No matter the Internet, the mobile communication apparatus or the personal digital assistant (PDA), they congest the space of the whole life. The Internet or the mobile supplier weeds through the old to bring forth the new and provides business service to assist the client in transmitting or receiving the data, so as to enlarge the scope of the market and the service. The electronic devices develop toward diversification and multi-function, such as the trend of lightness, thinness, shortness, smallness, multi-function and fast speed while the communication service provider or the information service provider also has to provide diversified, holistic and latest information to the client. Recently, the most used portable communication device includes mobile phones, which are increasingly popular in the normal person's life and become indispensable electronic produces, and the integration system of the electronic products congests the life. The new models of the mobile phone have to be developed at any time to enhance the market share. The service providers have to provide new service in time to win some clients over, so as to enlarge the market.

### SUMMARY

In view of those mentioned above, one object of the present invention is to provide a dynamic video message system stored in an access-able storage medium of a portable device.

The present invention provides a dynamic video message system stored in an accessible storage medium of a portable device, and coupled to a control unit of the portable device, wherein the dynamic video message system includes: a dynamic video address book provider to access to directory information; a dynamic video message generator coupled to the dynamic video address book provider and provided to generate a dynamic video message; and a transport provider coupled to the dynamic video message generator to handle message transmission and reception.

The device may include computer, notebook, tablet PC, tablet, AR device, VR device or smart phone. The dynamic video address book provider may include a contact person input interface generated by the dynamic video message system to input contact persons, and a dynamic video input interface generated by the dynamic video message system to input dynamic videos. The dynamic video address book provider may include a contact person related communication information input interface generated by the dynamic video message system to establish at least one contact person related communication information. The contact person related communication information may include telephone number, email account, blog URL, website address, Facebook account, instant messaging account, twitter account or any combination thereof. The dynamic video message may be stored in the portable device or a remote terminal. The dynamic videos in the dynamic video message may be captured by a digital camera module. The dynamic video message may include voice. The dynamic video message system may be coupled to a microphone and an image capturing device of the portable device to prepare the dynamic video message. The dynamic video message system may further comprise a spooler coupled to the dynamic video message generator and responsible for sending messages to and receiving message from a messaging system.

### BRIEF DESCRIPTION OF THE DRAWINGS

FIG. 1 illustrates a functional block diagram of the present invention;

FIG. 1A illustrates a functional block diagram of the present invention;

FIG. 2 illustrates a method diagram of the present invention;

FIG. 3 illustrates a method diagram of the present invention;

FIG. 4 illustrates a method diagram of the present invention;

FIG. 5 illustrates an address book diagram of the present invention; and

FIG. 6 illustrates an address diagram of the present invention.

### DETAILED DESCRIPTION

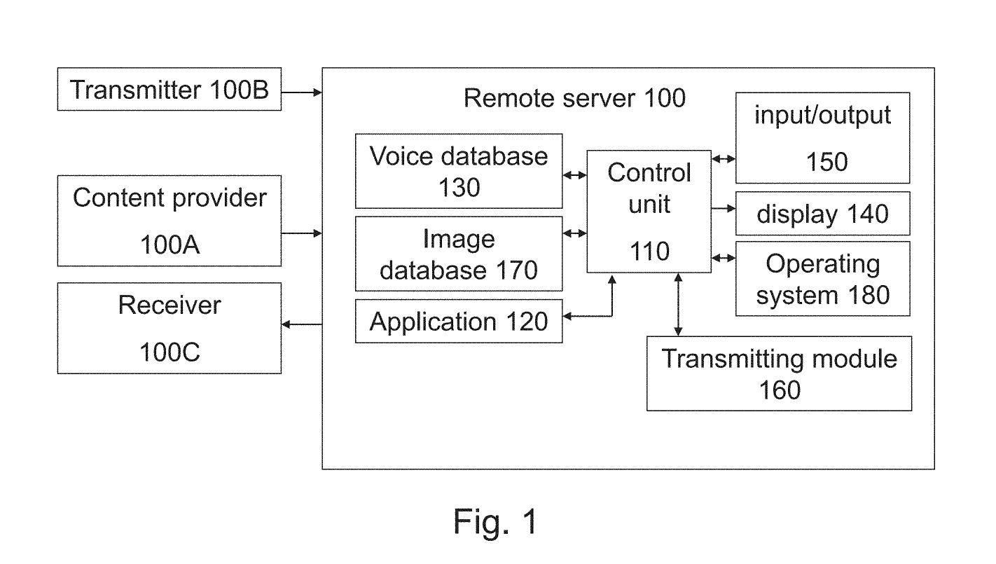

Some preferred embodiments of the invention will now be described in greater detail. Nevertheless, it should be recognized that the present invention can be practiced in a wide range of other embodiments besides those explicitly described, and the scope of the present invention is expressly not limited except as specified in the accompanying claims. FIG. 1 is a functional block and configuration diagram of the present invention. The portable communication device of the present invention includes mobile phone, tablet PC, media player or smart phone. The system configuration of a wireless communication device generally includes a wireless communication module adapted to bi-directional transmission protocols. The mobile phone at least includes a bi-directional communication module.

FIG. 1 illustrates a portable device which timely receives or downloads information from remote or cloud server or system 100 to process, store, compute or transmit messages, data or information. The cloud server or system 100 of the present invention includes voice database 130 and audio video database 170 coupled to the control unit 110. The user may upload, download, transmit or choose the desired audio video data or files and may set at the user terminal to store them in the address book and present them on the display of the user terminal. The user may modify the audio video data or files representing greetings or expressions at any time. The address book dynamic image setting application 120, the display 140, the input/output unit 150, the transmitting module 160 and the operating system 180 are coupled to the control unit 110 respectively. The address book dynamic image setting application 120 is configured in the remote or cloud server or system 100 to process the dynamic image set by the user through the user terminal, store the dynamic image in the memory device of the remote or cloud server or system 100 and transmit the dynamic image to the address book in the portable communication device of another (second) user terminal. The voice database 130 and the audio video database 170 are sent from the user terminal. Alternatively, the voice database 130 and the audio video database 170 may be provided by the service system or the content provider 100A, so as to provide other persons with spaces to create and provide diversified contents. The voice database 130 and the audio video database 170 may be classified according to different properties, such as sport type, recreation type, audio video entertainment type, vocal performance type, birthday greetings type, common regards type, festivity type, weddings and funerals type, console type, promotion and examination type, etc. The user terminal such as transmitter 100B may choose the video/audio files stored in the voice database 130 and the audio video database 170 by coupling to the audio video system 100 or select the files in his/her own electronic device (user terminal) to upload to the remote or cloud server or system 100. The system 100 may be an e-mail system, mobile phone short message system, mobile instant chat system, social media application and so on.

Please refer to FIG. 1A. In one case, the user terminal 100B or 100C includes a dynamic video message system 1000 coupled to a control unit 1100 and stored in a memory 1200 of the user terminal. In one embodiment, the dynamic video message system 1000 includes e-mail application, mobile phone short message application, mobile instant chat application, or social media application. The dynamic video message system 1000 is stored in a computer readable or accessible storage medium and comprises a dynamic video address book provider 1300 to access to directory information; a dynamic video message generator 1400 coupled to the dynamic video address book provider 1300 and provided to generate a dynamic video message; a spooler 1600 coupled to the dynamic video message generator 1400 and responsible for sending messages to and receiving message from a messaging system; and a transport provider 1700 coupled to the dynamic video message generator 1400 to handle message transmission and reception. The dynamic video message system is coupled to a microphone and an image capturing device of the user terminal to prepare the dynamic message. The spooler 1600 provides high-level function to implement sophisticated messaging features with a relatively small amount of code. The dynamic video message system 1000 is embedded into a computer readable medium of a computer, notebook or web server, a mobile phone, tablet, VR device, AR device or media player. The address book dynamic image setting application 120 of the present invention includes a core program, a transmitter information input interface module, a receiver information input interface module and a message input interface module, where the aforementioned interface modules may be transmitted to the apparatus at the user terminal. Thus, different dynamic images may be configured in the address books of the portable communication devices of different receivers. As known by the person having ordinary skill in the art, data may be uploaded or downloaded by the user terminal via the Internet or the telecommunication network, so as to bi-directionally transmit information. This may be appreciated by the person having ordinary skill in the computer software art. The transmitter may click and choose adaptive video/audio files via the present system in order for the chosen adaptive video/audio files in the system 100 or the user terminal, such as transmitter 100 B to be transmitted to adaptive receivers. For example, adaptive audio video files are received in the address book of the receiver's portable communication device at the receiver's birthday to play the greeting audio video messages, for instance the “Happy Birthday” audio video messages. 3G or 4G, 5G or higher version protocols may process data except process voice messages. The built-in WLAN module may receive wireless information to be displayed on the portable communication device. Therefore, the present system may transmit the designated file to the representative image of the address book of the portable communication device of the receiver via the Internet or the telecommunication network. The present system transmits the designated file to the representative image in the address book of the portable communication device of the receiver through the Internet or the telecommunication network, so as to enhance pleasures, convey emotions and provide more diversified service and convenience. The present system may provide other persons with customized space to create. The receivers may be surprised deeply to receive timely greetings unexpectedly, which enhances the fun of life insidiously. The system provider may also earn incomes via such mode or the advertisement.

Terminal devices may be coupled to the Internet via wired or wireless local area network, such as through wireless local area network composed of a plurality of access points. A plurality of subscriber terminal devices are connected with the telecommunication network (mobile phone communication network). In the same way, a plurality of subscriber terminal devices may also respectively be connected with the Internet wiredly or wirelessly. The number of the subscriber terminal devices may be arbitrary. As shown in the drawings, a computer is connected to the Internet, and the computer may be replaced with the following devices but is not limited to the following devices: for instance, personal digital assistant, notebook, smart phone, etc. The two networks are bridged through an exchange service mechanism. In other words, this exchange service mechanism enables two different types of networks to exchange data or connect with each other. This is a known technology and is not the key point of the present application. Therefore, the description thereof is omitted. The mobile phone and the personal digital assistant at least include a bi-directional communication module. For the bi-directional communication module, GSM, WCDMA, 4G or 3G or higher version protocols are utilized. The messages received by the bi-directional communication module and provided by the service provider are decoded by a decoding device to be transformed into recognizable signals. The wireless communication device includes a microprocessor or a central process unit and a user interface coupled to the microprocessor in order for the command to be inputted by employing for instance touch control or voice control (voice input). The signals received by the bi-directional communication module are processed by the microprocessor, which loads out the data or programs stored in the memory unit, such as communication protocol comparison, interpretation and judgement. The received information may be displayed on the display device. The mobile phone or the portable communication device generally includes a RF communication module, and an antenna is connected with a signal transceiver to receive or transmit signals. The RF communication module also includes a MODEM, a CODEC, a DSP (digital signal processor) and an A/D (analog/digital) converter. A central control IC is employed to control the processing of signals and data, electric power control and the processing of the output/inputted signals. An input unit, a built-in display unit, an operating system, an image capture unit, a power supply and a short-distance wireless transmission module (for example WiFi, WiMAX, Bluetooth, 802.11 (a [symbol] b [symbol] n [symbol] g) protocols or higher protocols) are electrically coupled to the process unit (the central control IC) respectively, so as to be wirelessly connected with external devices or the Internet. The communication device also includes memory coupled to the process unit (the central control IC) as the storage of data and the operating system. The memory may include read only memory (ROM), random access memory (RAM), non-volatile flash memory and so on according to different properties. The RF communication module may process the reception of the signal, the processing of baseband and the processing of the digital signals, etc. Finally, the voice signals are transmitted to the output device such as speaker/microphone unit. Generally, unchanged data may be stored in mask ROM while the system operating software or the fixed applications may typically be stored in non-volatile memory and other commands may be executed. The internal data therein may still be retained under no power state, and the non-volatile memory may be read out or be written in repeatedly when powered.

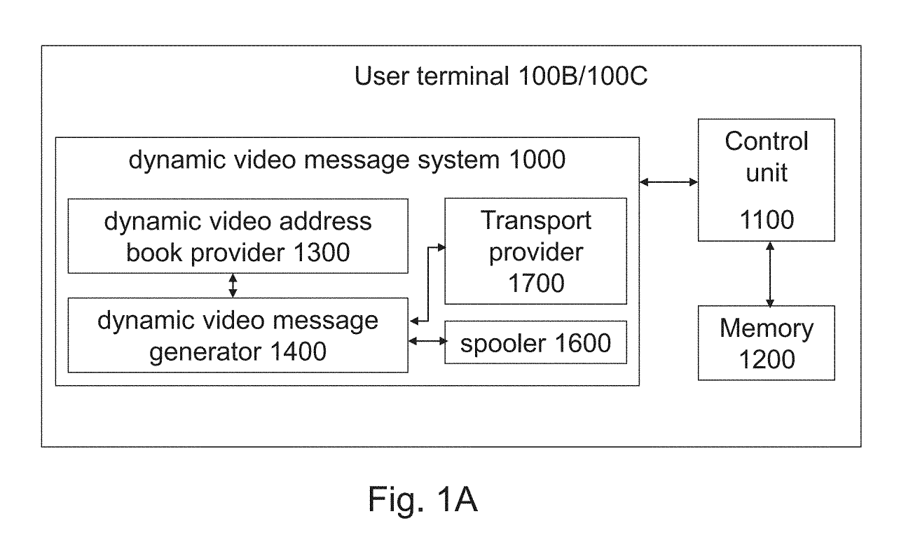

A method for establishing an address book which employs dynamic images (may include or may not include audio) to represent contact persons is shown in FIG. 2. The method includes: the address book application or command in a device is activated by the user through the user interface in step 2000, where the device may include computer, notebook, smart phone, tablet PC, etc. The user may be prompted by the display of the device to input or choose contact persons into the address book application or command in step 2100; the user inputs the dynamic images to represent the contact persons in step 2200 and optionally further inputs related communication information, which may include voices or texts, to establish one contact person news feed. The contact person related communication information may include telephone numbers, email address, blog URL, instant messaging account, Facebook account or Twitter account or the combination thereof. Subsequently, the user may store that contact person related communication information into the memory of the device through the user interface in step 2300 and optionally may upload the contact person related communication information to the remote or cloud server in step 2400 to complete the establishment of that contact person information.

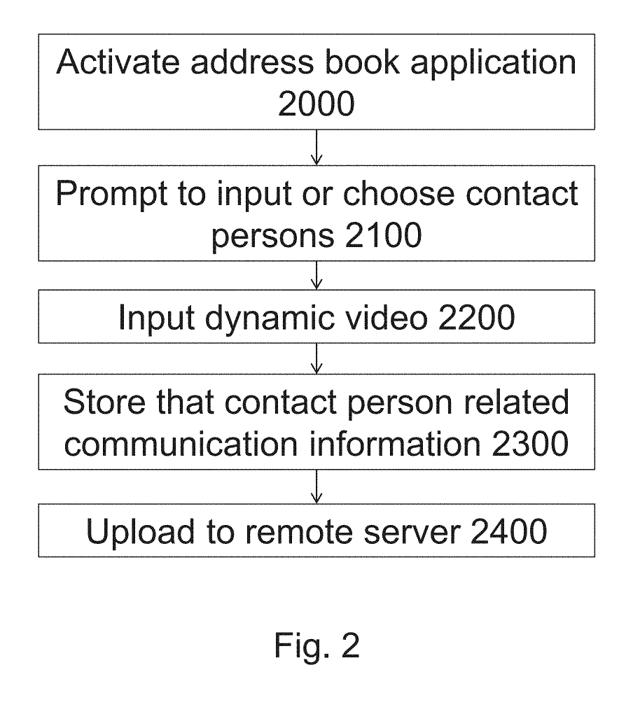

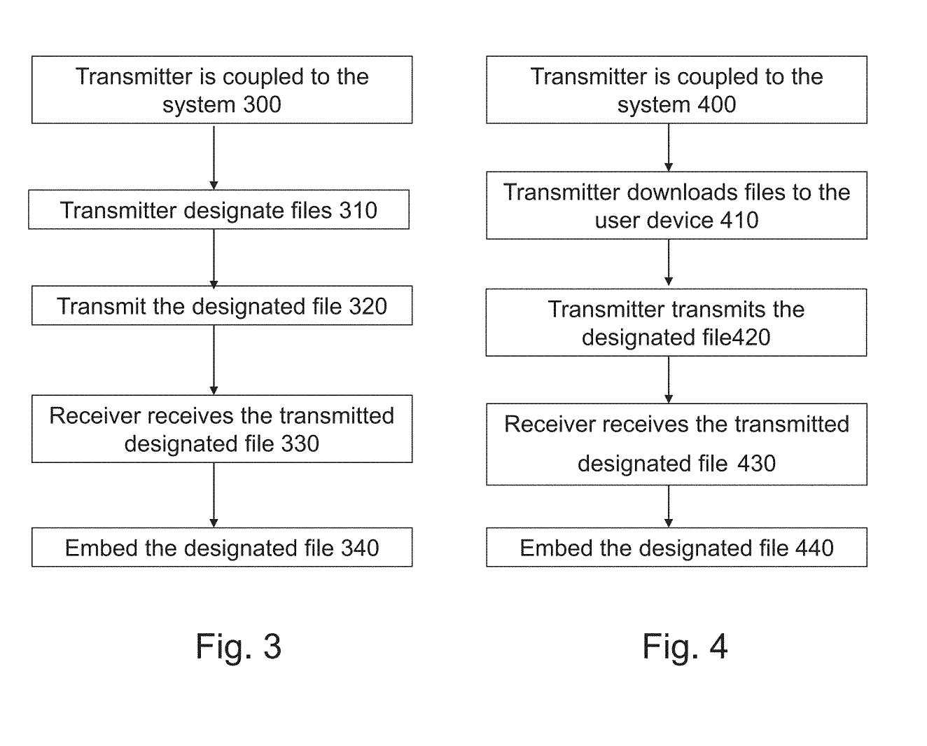

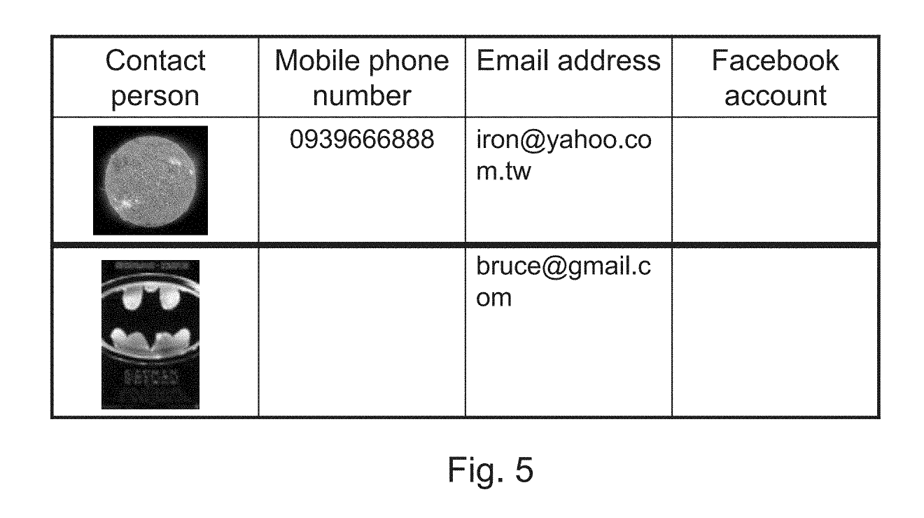

FIGS. 3 and 4 disclose other embodiments of the present invention respectively. Each of the embodiments may be performed separately or collectively. The transmitter (the user) is coupled to the remote or cloud server in step 300, and then clicks or designates the files to be transmitted (downloaded). In other words, the transmitter may designate file in step 310. After the transmitter inputs information such as the receiver information, the server transmits the file designated by the transmitter to the portable device of the designated receiver through for example the telecommunication network or the Internet in step 320. Then, the receiver receives the transmitted designated file in step 330, and embeds the designated file via the address book application in step 340 as shown in FIG. 5. The method shown in FIG. 4 is similar to that in FIG. 3 except that the user clicks and downloads the file into his/her terminal device in step 410 and transmits the file by himself/herself to the receiver in step 420.

In one exemplary embodiment, a RSS (Really Simple Syndication) is implanted into the address book of the portable device to subscribe to updated news or implant advertisement into the address book of the portable device. The user doesn't need to connect with the Internet to look up specific websites, but the subscribed news will be transmitted directly to the personal portable device to be displayed immediately. As long as the RSS location of the news provider or the adaptive news transmitting service system is copied to the reading software, the subscribing procedure is completed. When the reading software is activated or the customized home page is logged in, the updated contents can be received at any time. It should be noted that the method of the present invention doesn't need the subscriber to connect the network to enter a specific website and then look up the news. The RSS subscription may be customizedly set in the portable device such as the mobile phone. For example, a Widget tool or a Widget RSS reader may be implanted in the portable device, in order for the portable device to show various kinds of latest news. The RSS reading software may also be employed to follow blogs. The transmitting module of the present adaptive news or information transmitting service system may convey a keyword interface in order for the subscriber to customize keywords, so as to customize the desired news or information according to the keywords. For instance, if the user desires to follow the “global warming” news, he/she can set the aforementioned keyword into the system. When the matching module or the searching module finds out or detects news or information which matches or corresponds to the keywords set by the subscriber, that news or information may be transmitted to the portable communication device of the subscriber or the receiver. Therefore, the news transmitting service system may convey the keyword input interface in order for the subscriber to input keywords. The subscriber clicks the setting after inputting the keywords. The searched or matched news may be viewed via the applications in the portable device. The applications may be browsers or readers.

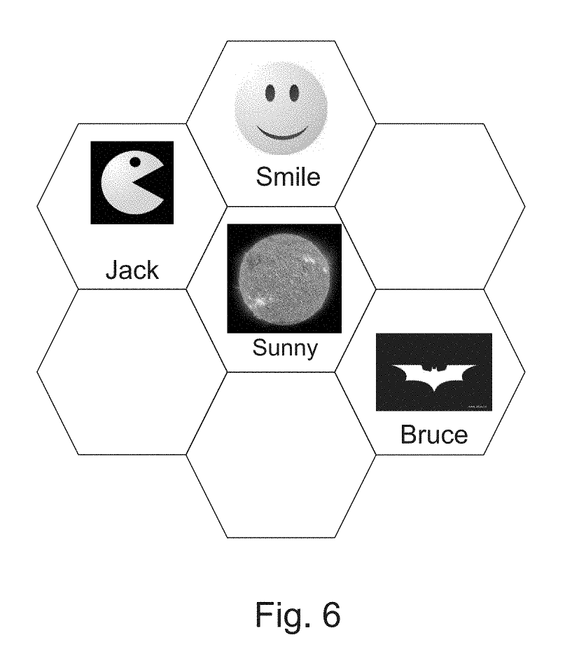

The present invention provides a dynamic image input representation method. Thus, after the address book or the phone book is activated, a dynamic image is employed to show, represent, replace or indicate a person (a natural person or a juristic person) for recognition. As an example, a digital camera module may be activated to capture a dynamic image to indicate the contact person and record voice information. If a dynamic image (video) of a contact person is captured, the address book application will generate a contact person utilizing the captured dynamic image and put it into the contact person field. If his/her nickname is piggy, a piglet picture may be utilized as the image to represent the contact person, so as to recognize the contact person and enhance pleasure. The corresponding relationship of the information thereof is shown in FIG. 5, which is only an example, not for limiting the present invention. For example, matrix arrangement, no communication data arrangement, no name arrangement, lateral arrangement, longitudinal arrangement, or honeycomb shaped arrangement as shown in FIG. 6 may be utilized. Based on the aforementioned, the device of the present invention includes the address book or the phone book stored therein, which employs dynamic images to represent the name of the natural person or the juristic person, so as to be presented on the portable communication device for recognition. The person having ordinary skill in the address book application art may write programs or implant programs or a contact person generating module to process them. Common computer conventional path indicating commands may also be utilized in order for the user to find out proper stored picture files in accordance with the path indications, so as to click them as the contact person representative image. Thus, the phone book application of the portable device may employ images to represent the contact persons and the related information. The related information may include mobile phone number, local telephone number, email address, internet phone address (number) or blog URL and may be one of the aforementioned or any combination thereof depending upon the need. This embodiment takes the portable device as an example, and is not limited thereto. Therefore, such embodiment may also be applied to computer, notebook, server, personal digital assistant, etc.

Aforementioned description is to illustrate purposes of the present invention, technical characteristics to achieve the purposes, and the advantages brought from the technical characteristics, and so on. And the present invention can be further understood by the following description of the preferred embodiment accompanying with the claim.

What is claimed is:

1. A dynamic video message system stored in an accessible storage medium of a portable device, and coupled to a control unit of said portable device, wherein said dynamic video message system includes:
a dynamic video address book provider to access to directory information;
a dynamic video message generator coupled to said dynamic video address book provider and provided to generate a dynamic video message; and
a transport provider coupled to said dynamic video message generator to handle message transmission and reception.

2. The dynamic video message system of claim 1, wherein said dynamic video address book provider includes a contact person input interface generated by said dynamic video message system to input contact persons, and a dynamic video input interface generated by said dynamic video message system to input dynamic videos.

3. The dynamic video message system of claim 1, wherein said dynamic video address book provider includes a contact person related communication information input interface generated by said dynamic video message system to establish at least one contact person related communication information, wherein said contact person related communication information includes telephone number, email account, blog URL, website address, Facebook account, instant messaging account, twitter account or any combination thereof.

4. The dynamic video message system of claim 1, wherein said portable device includes computer, notebook, tablet PC, tablet, AR device, VR device or smart phone.

5. The dynamic video message system of claim 1, wherein said dynamic video message is stored in said portable device or a remote terminal.

6. The dynamic video message system of claim 1, wherein dynamic videos in said dynamic video message are captured by a digital camera module.

7. The dynamic video message system of claim 1, wherein said dynamic video message includes voice.

8. The dynamic video message system of claim 1, wherein said dynamic video message system is coupled to a microphone and an image capturing device of said portable device to prepare said dynamic video message.

9. The dynamic video message system of claim 1, further comprising a spooler coupled to said dynamic video message generator and responsible for sending messages to and receiving message from a messaging system.

10. A dynamic video message system stored in an accessible storage medium of a portable device, and coupled to a control unit of said portable device, wherein said dynamic video message system includes:
a dynamic video address book provider to access to directory information;
a dynamic video message generator coupled to said dynamic video address book provider and provided to generate a dynamic video message;
a spooler coupled to said dynamic video message generator and responsible for sending messages to and receiving message from a messaging system; and
a transport provider coupled to said dynamic video message generator to handle message transmission and reception; wherein said dynamic video message system is coupled to a microphone and an image capturing device of said portable device to prepare said dynamic video message;
wherein said dynamic video address book provider includes a contact person input interface generated by said dynamic video message system to input contact persons, and a dynamic video input interface generated by said dynamic video message system to input dynamic videos.

11. The dynamic video message system of claim 10, wherein said dynamic video address book provider includes a contact person related communication information input interface generated by said dynamic video message system to establish at least one contact person related communication information, wherein said contact person related communication information includes telephone number, email account, blog URL, website address, Facebook account, instant messaging account, twitter account or any combination thereof.

12. The dynamic video message system of claim 10, wherein said portable device includes computer, notebook, tablet PC, tablet, AR device, VR device or smart phone.

13. The dynamic video message system of claim 10, wherein said dynamic videos are stored in said portable device or a remote terminal.

14. The dynamic video message system of claim 10, wherein said dynamic videos are captured by a digital camera module.

15. The dynamic video message system of claim 10, wherein said dynamic videos include voice.

16. The dynamic video message system of claim 10, wherein said spooler is provided to implement sophisticated messaging features.
